(19) United States
(12) Patent Application Publication
(10) Pub. No.: US 2004/0073517 A1
(43) Pub. Date: Apr. 15, 2004

(54) Method for determining a licensing policy of a digital product

(76) Inventors: Michael Zunke, Seefeld (DE); Yanki Margalit, Ramat-Gan (IL); Dany Margalit, Ramat-Gan (IL)

Correspondence Address: DR.MARK FRIEDMAN LTD., c/o Bill Polkinghorn, Discovery Dispatch, 9003 Florin Way, Upper Marlboro, MD, 20772, US

(21) Appl. No.: 10/612,921

(22) Filed: Jul. 7, 2003

Related U.S. Application Data
(60) Provisional application No. 60/393,516, filed on Jul. 5, 2002.

(51) Int. Cl. G06F 17/60

(52) U.S. Cl. 705/59

(57) ABSTRACT

A method for determining a licensing policy of using a digital product by a group of users, comprises conducting a tolerant licensing policy during a trial period, monitoring usage parameter(s) of the digital product during the trial period, examining the performance of the licensing policy according to samples of the monitored parameter(s), and determining a new licensing policy according to the examination. Optionally, the newly determined licensing policy can be monitored during a subsequent period, after which the licensing policy can be examined and adjusted accordingly. According to one embodiment of the invention, the group of users is determined manually. According to another embodiment of the invention, the group of users is determined automatically, by e.g. the N users that have used the product in general or for a predefined period.

### CROSS REFERENCE TO EXISTING APPLICATIONS

The present invention claims priority from U.S. Provisional Application No. 60/393,516, filed Jul. 5, 2002

### FIELD OF THE INVENTION

The present invention relates to the field of licensing digital products.

### BACKGROUND OF THE INVENTION

An organization that purchases licenses for using a digital product (software, multimedia file, etc.) has to deal with two opposing tendencies. On the one hand the organization is interested in purchasing as few licenses as possible in order to diminish the cost. On the other hand, the number of required licenses at a certain moment can exceed the number of purchased licenses, and consequently, some users will not be able to use the product at a critical moment. Typically the organization deals with the problem by conducting a “licensing policy”, which determines, for example, how many licenses to purchase and how to share them between the users.

From the technical point of view, the subject of licensing of a digital product may be managed by a Licensing Management Server (LMS), which is installed within the organization's local area network(s). Such a server may also be connected to the vendor's system via the Internet. In fact, the LMS operates like the vendor's agent. FIG. 1 schematically illustrates a licensing management system, according to the prior art. Consumers 10, which are interconnected by a local area network 30, are using a licensed digital product. A LMS 20, which is also connected to local area network 30, enforces the licensing policy of the digital product. Issuing a license for using the digital product may be carried out by posting a request for license from the consumer's computer to LMS 20. LMS 20 looks for available licenses in a “licensing pool”, and if free licenses are available, the consumer is provided with a license. Whenever the user terminates use of the digital product, one license is added to the licensing pool. Another consumer 11 is connected to LMS 20 via an Internet network 40. LMS 20 may be connected also to a vendor computer 50, which issues the licenses to the licensing pool. Vendor computer 50 can update the licensing policy of LMS 20 through Internet 40. For example, at the beginning of each month, LMS 20 gets the number of issued licenses from the vendor computer 50. It should be noted that consumer 10 may be either a consumer or the machine upon which the digital product is used (i.e. displayed, executed, etc.).

Of course, in the prior art there are other licensing methods and systems, and the above-detailed description is only an example. However, none of the prior art licensing methods provides a satisfactory solution to the problem of determining a licensing policy that reflects the real needs of an organization.

It is therefore an object of the present invention to provide a method and system for determining a licensing policy that reflects the real needs of an organization. It is a further object of the present invention to provide a method and system for determining a licensing policy, by which the determination process can be carried out automatically. Other objects and advantages of the invention will become apparent as the description proceeds.

### SUMMARY OF THE INVENTION

The present invention is of a method for determining a licensing policy of using a digital product by a group of users.

According to the present invention there is provided a method for determining a licensing policy of using at least one digital product by at least one user, comprising the steps of conducting a tolerant licensing policy for the use of the at least one digital product by the at least one user during a trial period, monitoring at least one parameter of the use during the trial period, and determining a licensing policy according to the monitoring of the at least one parameter to obtain a determined licensing policy.

Optionally, the determined licensing policy may be monitored during a subsequent period, after which the licensing policy can be re-examined and re-adjusted or re-determined accordingly. According to one embodiment of the invention, the group of users is determined manually. According to another embodiment of the invention, the group of users is determined automatically, by e.g. the N users that have used the product and/or the N users that have used the product for a predefined period.

According to the present invention there is provided a method for determining a number of available licenses in a licensing pool, the licenses directed for the use of at least one digital product by at least one user, the method comprising the steps of issuing a tolerant maximum number of licenses to the licensing pool, complying with the maximum number of licenses from the pool that come from the at least one user and monitoring a count of the issued licenses, and, when the trial period is over, determining the maximum available licenses in the pool.

### BRIEF DESCRIPTION OF THE DRAWINGS

The invention is herein described, by way of example only, with reference to the accompanying drawings, wherein:

FIG. 1 schematically illustrates a licensing management system, according to the prior art;

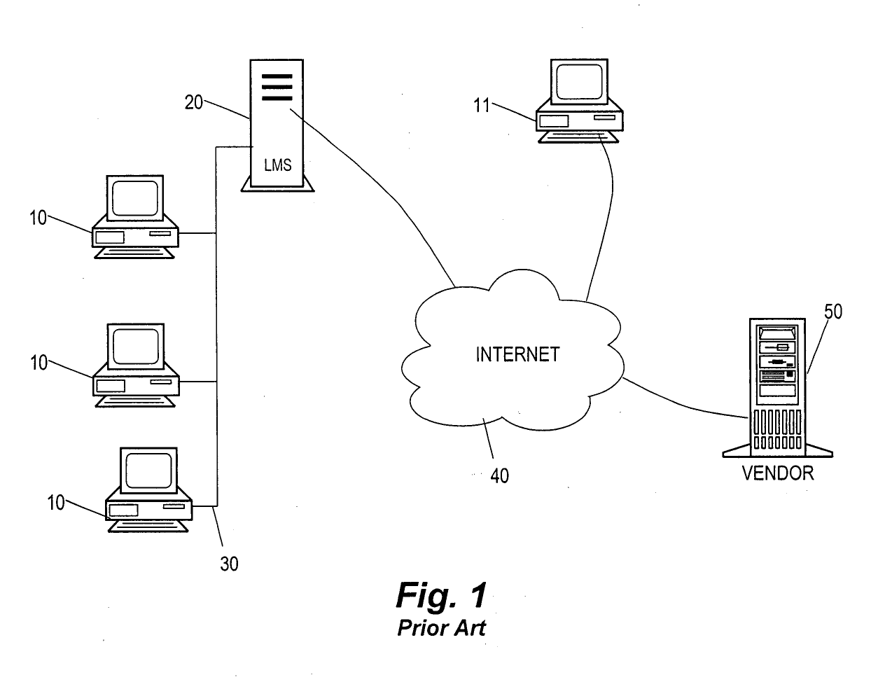

FIG. 2 is a high-level flowchart of a process for determining a licensing policy, according to a preferred embodiment of the invention;

FIG. 3 is a high-level flowchart of a process for determining a licensing policy, according to another preferred embodiment of the invention;

### DESCRIPTION OF THE PREFERRED EMBODIMENTS

The term “tolerant licensing policy for using a digital product by a group of users” refers herein to a licensing policy by which the group of users is entitled to use the product with fewer restrictions than in a future licensing arrangement, or without restrictions at all. In one example, a policy by which more licenses are available to an organization than actually required is a tolerant licensing policy for using that product by that organization. In another example, a tolerant licensing policy is defined as a policy upon by which a license is provided to any member of an organization that asks for a license.

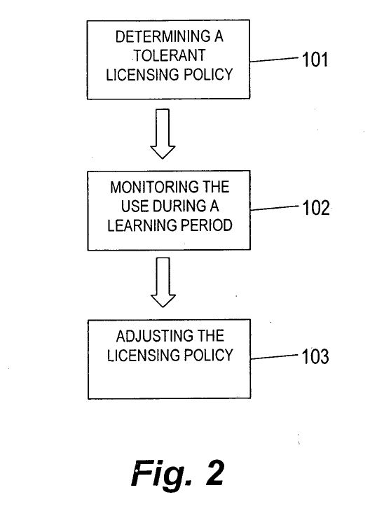

FIG. 2 is a high-level flowchart of a process for determining a licensing policy, according to a preferred embodiment of the present invention. At step 101, the organization conducts a tolerant licensing policy of a digital product. For example, every request for a license for using the digital product is compiled. At step 102, the licensing policy is monitored during a “trial period”, e.g. two months. The details of the issued and/or requested licenses are registered in a database. Additional parameters of usage may also be registered in the database, e.g., the time of posting of a request for a license, the time a license is in use by a user, which parts of the digital product have been used during the session, how many users have been in the licensing queue, how long the user had to wait until the license has been issued, and so forth. At step 103, when the trial period is over, the licensing policy that was conducted during the trial period is examined and adjusted accordingly; or alternatively, a new licensing policy is determined. In both cases, the “new” licensing policy resulting from the previous steps that include the tolerant licensing policy use is referred to as an “determined” licensing policy.

For example, an organization intends to purchase licenses for using a digital product, e.g. a spreadsheet software, but it has no indication about the quantity of licenses required by the organization. During the first month, which is used as a trial period, the organization gets N licenses, where N is greater than the number of the members of the organization. During the trial period, the usage is monitored, and the usage information is registered in a database. The usage parameters may be one or more of the parameters listed above. After the trial period is over, the organization determines the quantity of licenses to purchase. The quantity of licenses to purchase (in an adjusted licensing policy according to the present invention) may be determined, for example, by the number of users that used the product for at least three times during the trial period (e.g. 150 users used the product 4 times, 200 users used the product 3 times, 250 used the product 2 times, and 400 users used the product one time, thus 150+200=350 licenses).

According to another example, the licensing server runs a licensing pool of N (e.g. 1000) licenses. Each time a user wants to use the digital product, a request for license is posted to the licensing server. The licensing server issues a license only if there are available licenses. Each time a license is issued, the number of available licenses is decreased by 1, and each time a user finishes working with the licensed product, the number of licenses is increased by 1. During the trial period, the licensing pool is “filled up” with a greater number of licenses than the number of expected requests (the latter matching, for example, the number of employees of the organizations which is therefore smaller than N). After the trial period is over, an adjusted licensing policy is determined according to a “licensing criterion”, based on the data gathered during the trial period. An example for a licensing criterion may be a certain percentage of the maximum licenses that were indicated to be used at the same (concurrent) time. For example, if 400 of 1000 licenses have been so indicated, the organization may purchase 400 licenses, or some percentage of this amount.

Generally, the step of determining (or adjusting) a licensing policy can be carried out according to a “run count” (e.g. the number of times licenses have been issued, the number of times a license has been requested, the number of times a user gave up requesting a license, etc.), and/or according to a “time count” (e.g. the time of posting of a request for a license, the time a license is in use by a user, the average time a user has to wait in a licensing queue until a license is issued, etc.). The calculation can take into consideration, for example, the minimum, maximum, and average of a sampled parameter. The parameter may be for example the number of licenses issued during a specified period such as a week, 2 months, etc, in which case the respective minimum, maximum and average values of the parameter are the minimum, maximum, and average number of licenses issued during that period. If the parameter is for example the number of licenses used per day, minimum, maximum and average parameter values are defined for the number of licenses used per day.

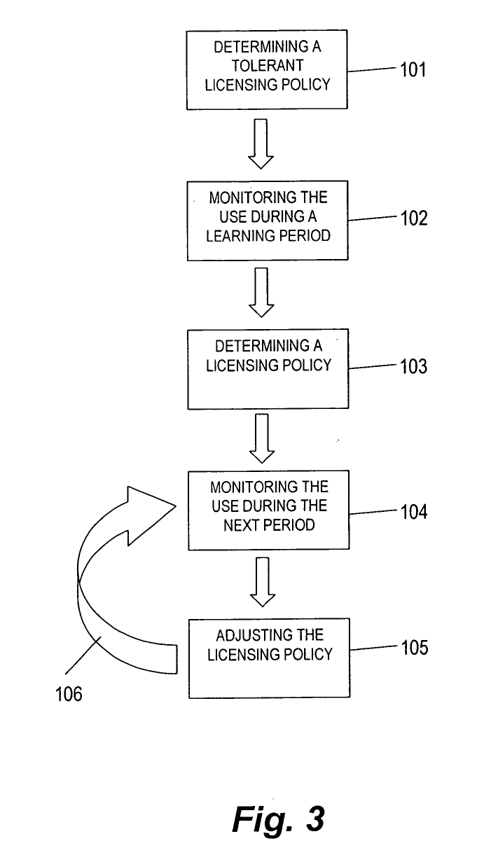

FIG. 3 is a high-level flowchart of a process for determining a licensing policy, according to another preferred embodiment of the present invention. In general every period can be a trial period. Therefore, the cycle of trying a licensing policy and adjusting the policy (or determining a new policy) can be conducted as illustrated by FIG. 3. After the first instance of obtaining a fist adjusted licensing policy (i.e. adjusting an existing licensing policy or determining a new one for the first time—step 103), a following period is used for monitoring the adjusted licensing usage (step 104), and at the end of this period, the licensing policy is re-adjusted or alternatively a new adjusted licensing policy is conducted (step 105). Thus steps 104 and 105 can be repeated in a loop, as indicated by an arrow 106. Whenever the number of purchased licenses is changed, the licensing server can inform the vendor (or vendor's server) about the updated number of licenses. The Internet technology enables the connection between the licensing server and the vendor's server, and therefore this process may be carried out automatically.

It should be noted that the licenses can be issued to users and/or to computers. Practically, users and machines can each be identified by a unique ID. For example, each user uses a PIN (Personal Identification Number), which should be provided whenever the user requests a license from the licensing server. Additionally or alternatively, each computer may store a unique ID, which is transmitted to the licensing server with the request for a license. This way, machines with a preinstalled ID may be used for every member of the organization, and machines without a preinstalled ID may be used only by providing an ID by the user. Thus, the term “user” refers herein to a human user and/or to a machine.

A licensing policy may depend on a period of the year, month, week, day, etc. For example, in the summer fewer licenses are required due to vacations. In principle, every period can be the trial period for a corresponding period in another time frame. For example, August 2002 can be the trial period for August 2003, Monday 11 can be the trial period for Monday 18, and so forth.

According to another embodiment of the invention, the users are ranked by a priority level, which may be determined according to data gathered during the learning period and/or arbitrarily by the system manager. After the trial period is over, whenever users of different priority are waiting in the queue for a license, the user with the highest priority gets the first available license. The priority of a user waiting in a licensing queue can be upgraded according to the time passed since he entered the queue. For example, each 2 minutes the priority of the waiting user is increased. Thus, at a certain moment, a user waiting in a licensing queue can be of the highest priority among the users waiting in the licensing pool queue, despite of the fact that other users have higher default priority. Determining the priority can be carried out by using, for example, the accumulated time a user has been using the license during the period, the number of times the license has been issued, the position of the user within the organization, and so forth.

According to a preferred embodiment of the invention, the pool is sub-divided according to the organization's departments (i.e. sub-groups). For example, department A is limited to 10 licenses, department B is limited to 10 licenses, department C to 30 licenses, and so forth. In this case each department is treated like an independent organization having its own pool of licenses. However, the tolerant licensing policy can determine that users of departments A can get their own 10 licenses, plus 5 licenses of department B.

According to one embodiment of the invention, the initial number of licenses, i.e. the tolerant licensing policy, is determined by the system administrator according to his/her assumptions as to what should be considered a tolerant licensing policy. In general, the system administrator should be able to interfere within the automatic process of determining the licensing policy at every stage, since the conditions may change, e.g. reducing the number of available licenses due to the effort of the enterprise to diminish its expenses. It should be noted that the group of users does not necessarily have to include all the users of an organization, but merely certain users. Moreover, these users may be determined arbitrary by the system administrator, or automatically by the LMS. For example, the group of users may be defined as the first N users that have used the product, the first N users that have used the product for at least 30 minutes, and so forth.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made. Those skilled in the art will appreciate that the invention can be embodied by other forms and ways, without losing the scope of the invention. The embodiments described herein should be considered as illustrative and not restrictive.

What is claimed is:

1. A method for determining a licensing policy of using at least one digital product by at least one user, comprising the steps of:
(a) conducting a tolerant licensing policy for the use of the at least one digital product by the at least one user during a trial period;
(b) monitoring at least one parameter of said use during said trial period; and
(c) determining a licensing policy according to said monitoring of said at least one parameter to obtain a determined licensing policy.

2. The method of claim 1, wherein said step of monitoring includes collecting at least one sample of said at least one parameter, and wherein said step of determining includes evaluating the performance of said tolerant licensing policy according based on said at least one sample.

3. The method of claim 1, further comprising steps of, in at least one loop, re-evaluating said determined licensing policy, and optimizing said determined policy according to said re-evaluation.

4. The method of claim 1, wherein said tolerant licensing policy comprises at least one rule being less restrictive than a corresponding rule of said determined licensing policy.

5. The method of claim 1, wherein said tolerant licensing policy includes free usage of the at least one digital product during said trial period.

6. The method of claim 1, wherein said at least one parameter is selected from a group consisting of a time count and a run count.

7. The method of claim 6, wherein said time count is selected from the group consisting of the time of posting of a request for a license, the time a license is in use by a user, and the average time a user has to wait in a licensing queue until a license is issued.

8. The method of claim 6, wherein said run count is selected from the group consisting of the number of times licenses have been issued, the number of times a license has been requested, and the number of times a user gave up requesting a license.

9. The method of claim 1, wherein said at least one user is selected from the group consisting of at least one machine, at least one organization and at least one department of an organization.

10. The method of claim 1, wherein said at least one user is defined manually.

11. The method of claim 1, wherein said at least one user is defined automatically.

12. The method of claim 1, wherein said at least one user is selected from the group consisting of the first N users that invoked said product during a first predefined period, the first N users that used said product for at least a predetermined duration during a predefined period, and a combination thereof.

13. The method of claim 1, further comprising ranking said at least one user, and issuing a license to the user having the highest rank among the users waiting in a licensing queue.

14. A method according to claim 13, wherein the rank of a user waiting in a licensing queue is upgraded according to the waiting time of said user in said queue.

15. A method for determining a number of available licenses in a licensing pool, the licenses directed for the use of at least one digital product by at least one user, the method comprising the steps of:
(a) issuing a tolerant maximum number of licenses to said licensing pool;
(b) complying with said maximum number of licenses from said pool that come from said at least one user, and monitoring a count of the issued licenses; and
(c) when said trial period is over, determining the maximum available licenses in said pool by implementing at least one optimization method based on said monitoring.

16. The method of claim 15, wherein said count is selected from the group consisting of a time count and a run count.

17. The method of claim 15, further comprising the steps of repeating steps (b) and (c) in at least one loop

18. The method of claim 15, wherein said optimization method includes counting a percentage of the licenses being used in a time unit.

19. The method of claim 15, wherein said at least one optimization method includes counting the number of maximum licenses being used at the same time.

20. The method of claim 15, further comprising ranking said at least one user, and issuing a license to a user having the highest rank among users waiting in a licensing queue.

21. The method of claim 20, wherein said rank of a user waiting in a licensing queue is upgraded according to the waiting time of said user in said queue.

22. The method of claim 20, wherein said rank of a user is determined according to his hierarchy among said at least one users.
